(19) United States
(12) Patent Application Publication
(10) Pub. No.: US 2009/0083097 A1
(43) Pub. Date: Mar. 26, 2009

(54) Process for water storage facilities

(76) Inventor: Chris Boyd, Sandersville, GA (US)

Correspondence Address: Harold H. Flanders, 904 Sweetwater Cove, Round Rock, TX, 78681, US

(21) Appl. No.: 11/903,196

(22) Filed: Sep. 20, 2007

(51) Int. Cl. G06Q 90/00

(52) U.S. Cl. 705/7

(57) ABSTRACT

The present invention provides a process comprising the evaluation, planning, and provision of maintenance and repair services for water storage facilities on an ongoing, integrated and monitored basis including the use of comprehensive maintenance and state of the art cleaning and circulation technologies.

### BACKGROUND OF THE INVENTION

1. Field of the Invention

The present invention relates generally to a process applicable to water storage facilities and more particularly to a new and improved method for the evaluation, planning, and provision of maintenance and repair for water storage facilities on an ongoing, integrated basis and for such other structure, apparatus, processes, systems, and methods as may be herein disclosed.

2. Relevant State of the Art and Description of Related Prior Art

Everything done in this area of technology is related in one way or another to the most stringent applicable regulations. Notable among these are the US EPA Safe Drinking Water Act, the National Interim Primary Drinking Water Reg.'s—40 CFR and the California Safe Drinking Water Act—Title 22. The applicability and enforcement is carried out by the California DHS and the EPA as applicable in general to any water supplier except for private wells serving under 25 individuals or 15 service connections. The state and Federal regulations establishes the criterion for testing frequency and regulated concentrations of heavy metals, organic compounds inorganic compounds, bi-products and the like with the focus being on bacteria and organic compounds

The interest in bacteria relates to the immediate and traceable health effects and the potential for catastrophic health effects from wide spread sources with many having common contact with surface water. The ability of bacteria to rapidly multiply is a major concern. See for example Appendix E of Paul G Hewitt's Conceptual Physics, 10^{th} Ed., Pearson/Addison Wesley, 2006, for a treatment of Exponential Growth and Doubling Time adapted from A. A. Bartlett's journal articles, materials and presentations.

Organic Compounds are commonly found in surface water and may combine with chlorine to form Trihalomethanes (TTHM) and Haloacetic Acids (HAA5) which are impacted by significant regulatory changes.

In the prior art treatment methods when bacteria was of concern in water samples the solution was to add chorine while attempting to avoid a residual chlorine level in excess of 0.4 mg/l. The applicable regulation required only 4 samples/quarter and e coli and fecal bacteria were not reported.

More recent and current regulations require 120 samples/week and any bacteria detection requiring retesting with 5% positive test samples requiring public alert as does any e coli or fecal bacteria.

Disinfection bi-products are limited to 80 ppb. Future regulations will apparently require increased test frequency and limit TTHM to 80 ppb and HM5 to 60 ppb in any sample.

Reduction of chlorine may lead to bacterial growth while over-chlorination may lead to TTHM/HM5.

Other treatment alternatives such a filtration treatments, ozone treatments, and chloramine treatments have well known limitations which prohibit them from being the solution to the problem's outlined above or in some cases they have limitations which may actually cause the problem to be made worse such as nitrification in the chloramine process which promotes bacterial growth.

The potable water storage facility may be and in most cases is a collection point for organic debris and may provide minimal water movement which results in a failure to disturb or dislodge bacterial growth and insufficient circulation of added chemicals. Surface irregularities may coat over spray, blister, delimitation and rust and provide ideal mechanical anchors for the bacteria to adhere, multiply and be shielded from treatment chemicals such as chlorine.

As is well known water storage tanks accumulate surface deposits and scale over a period of time. These deposits are usually mineral components such as calcium iron and manganese; and biofilms. These deposits can affect water quality and contribute to tank corrosion.

Typical methods that are used to clean these surfaces are mechanical means, such as pressure washing and removing sediment by vacuum or robots; and chemical means, such as acid treatment. Acids, primarily hydrochloric and sulfamic, are used to dissolve the mineral components. Chlorine is used to control biofilm.

As indicated above acids of all types and oxidizers such as hydrogen peroxide are the most common cleaning systems U.S. Pat. No. 4,199,469 (16980) teaches a wide range of acids for cleaning and the use of disinfectants Hawley's 9^{th} ED of 1977 and Merck's 10^{th} Ed of 1983 both describe sulfamic acid as a known cleaning agent. Other compositions disclosed contain ascorbic acid, hydrochloric acid, phosphoric acid, formic acid, citric acid, isopropyl alcohol, and corrosion inhibitors Other disinfectants may also be used.

U.S. Pat. No. 5,360,488 (1994) employs a mixture of mineral and organic acids, the mineral acids are selected from hydrochloric, nitric, phosphoric, polyphosphoric, hydrofluoric, boric, sulphuric and sulphurous The organic acid is selected from formic acetic, propionic, citric, glycolic, lactic, tartaric, polyacrylic, succinic and p-toluenesulfonic. The acid treatment solution may contain other additives such as inhibitors, chelating agents, and dispersing agents.

U.S. Pat. No. 6,346,217 (2002) teaches amidoculfonic acid, nitrilotriacetic acid, isopropanol and water. This composition may be mixed with a disinfectant solution of peroxoacetic acid.

Pat. Appl 20020094941 contains a cleaning solution comprising sulfamic acid, citric acid, glycolic acid, phosphoric, rodine, hydrochloric acid, inhibitors, dyes and water. The disinfectant portion is hydrogen peroxide or peracidic acid.

US Appl. 20060043028 teaches a cleaning process for water filtration media by applying a granular cleaner and a catalyst. The cleaning composition may contain sulfamic acid a, citric acid, hydrochloric acid, phosphoric acid, corrosion inhibitors surfactants and sodium bicarbonate. The catalyst is selected from hydrogen peroxide or peracetic acid.

Lawlor's U.S. Pat. No. 2,128,617 (1938) teaches the use of a central two-way pipe with appropriate check valves to provide circulation.

Raftis' U.S. Pat. No. 7,104,279 provides a manifold structure relative to the size and shape of a storage tank.

Duck bill check valves are shown in Kahl U.S. Pat. No. 171,817 (1876) Bochan U.S. Pat. No. 3,118,458 (1964) and Grise U.S. Pat. No. 3,422,844 (1969)

A number of orientations are shown in Hyatt U.S. Pat. No. 273,539

(1883) Jewell U.S. Pat. No. 377,390 and 418,335 (1888) and Evans U.S. Pat. No. 4,013,556 (1977)

Other methods of agitation are taught by U.S. Pat. No. 6,435,209 and the prior art cited therein.

The term biological deposits, biofilm and the like are intended to include Eubacteria, aerobic and anaerobic; Archaeabacteria; certain Protistans, such as molds; and Fungi.

The terms acids and bases and oxidizing agents and reducing agents as used herein include the following

Arrhenius acids and bases where an acid contains hydrogen and releases hydrogen ions when dissolved in water.

Bronsted-Lowry acids and bases where an acid is a proton donor.

Lewis acids and bases in which a Lewis acid can accept a pair of electrons and the base can donate a pair of electrons and oxidation is the loss of electrons.

And, Usanovich acids and bases in which an acid is a hole, that is the absence of an electron from a distribution of electronic charge or a vacancy in an orbital and a base is an electron.

For further details, see P. W. Atkins, Atoms, Electrons and Change, Scientific American Library, 1991, page 44-72.

### BRIEF SUMMARY OF THE INVENTION

The present invention provides a process comprising the evaluation, planning, and provision of maintenance and repair services for water storage facilities on an ongoing, integrated and monitored basis including the use of comprehensive maintenance and state of the art cleaning and circulation technologies.

The present invention comprises a process for the maintenance and repair of water storage facilities comprising:
(a) evaluating and planning for maintenance and repair services for water storage facilities;
(b) providing comprehensive maintenance of said water storage facilities;
(c) providing initial cleaning of said water storage facilities;
(d) providing periodic cleaning of said water storage facilities thereafter; and
(e) providing circulation of the water in said water storage facilities between said periodic cleanings.

The provision of the services may be based on ongoing monitoring of the compliance with regulatory requirements within the water storage facility, including the computer monitoring of physical, chemical and/or biological conditions within the water storage facility.

In many if not most cases the water storage facility includes a water storage tank. The circulation of the water in the water storage facility is intended to provide for laminar or near laminar flow in the circulation patterns of the water. The cleaning of the tank includes chemical cleaning, and the effective removal of chemical and biological deposits, to render the system safe as a potable water source.

The cleaning pattern which is preferred will produce a saw-tooth pattern as measured by the amount of one or more chemical/biological contaminants being monitored. The saw tooth curve will have maximum and minimum points which are repeated more than once in the time period that would otherwise lead to system failure, major repair, or replacement.

### OBJECTS

Pursuant to the foregoing, it may be regarded as an object of the present invention to overcome the deficiencies of and provide for improvements in the state of the prior art as described above and as may be inherent in the same or as may be known to those skilled in the art.

It is a further object of the present invention to provide a process and any necessary apparatus for carrying out the same and of the forgoing character and in accordance with the above objects which may be readily carried out with and within the process and with comparatively simple equipment and with relatively simple engineering requirements.

Still further objects may be recognized and become apparent upon consideration of the following specification, taken as a whole, in conjunction with the appended drawings and claims, wherein by way of illustration and example, an embodiment of the present invention is disclosed.

As used herein, any reference to an object of the present invention should be understood to refer to solutions and advantages of the present invention which flow from its conception and reduction to practice and not to any a prior or prior art conception

The above and other objects of the present invention are realized and the limitations of the prior art are overcome by providing a new and improved method and process applicable to water storage facilities.

### TECHNICAL PROBLEMS TO BE SOLVED

The need for an integrated process which provides for the evaluation, planning, and provision of proactive comprehensive maintenance and repair needs including the use of state of the art cleaning and circulation technologies for water storage facilities on an ongoing, integrated basis has long existed and been unfulfilled prior to the invention of the present process.

### BRIEF DESCRIPTION OF THE DRAWINGS AND THEIR SEVERAL VIEWS

The above mentioned and other objects and advantages of the present invention and a better understanding of the principles and details of the present invention will be evident from description taken in conjunction with the appended drawings.

The drawings constitute a part of this specification and include exemplary embodiments of the present invention, which may be embodied in various forms. It is to be understood that in some instances various aspects of the invention may be shown as exaggerated, reduced, or enlarged or otherwise distorted to facilitate an understanding of the present invention.

In the drawings appended hereto:

FIG. 1 is a schematic flow sheet showing the steps of the present invention, not all of which are necessarily employed in each and every situation.

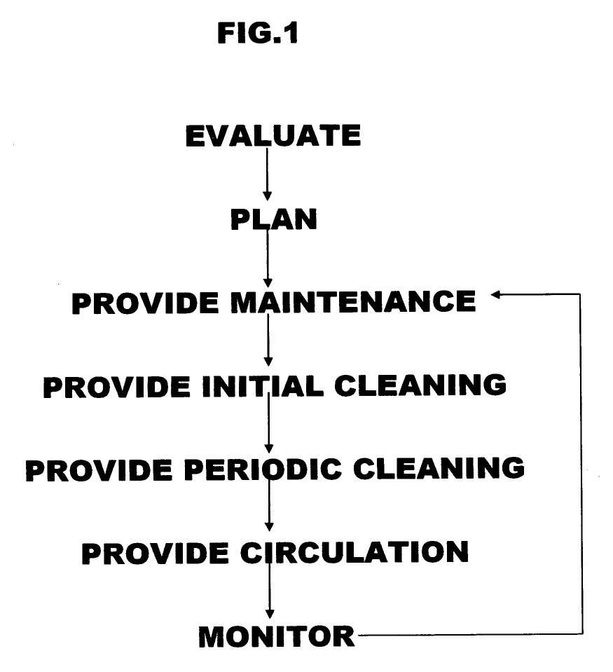

FIG. 2 is a chart showing the advantages of an integrated saw-tooth maintenance scheme vs. replacement or major overhaul as a function of time.

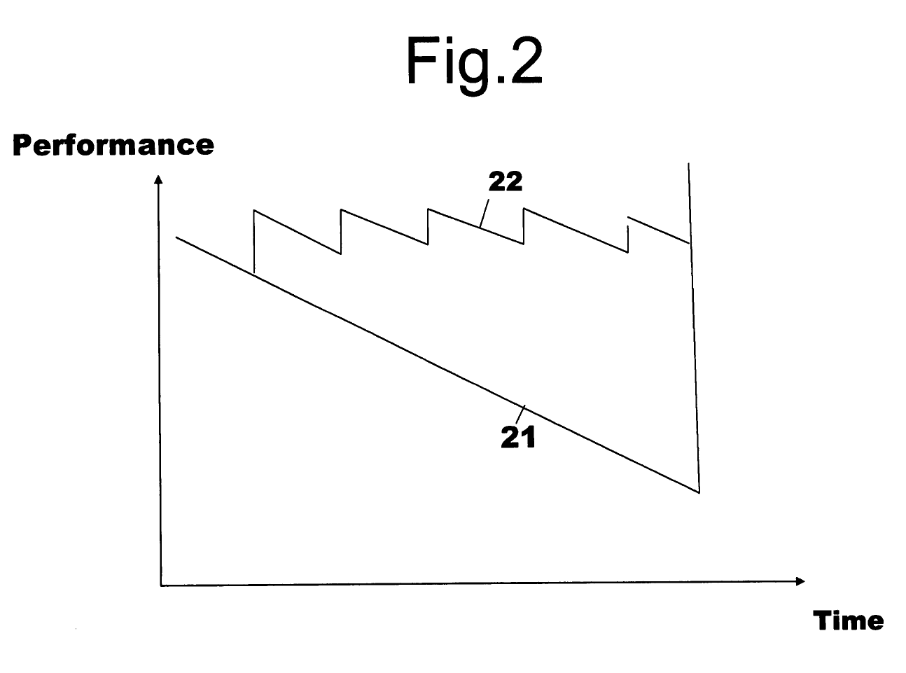

In the accompanying drawings, like elements are given the same or analogous references when convenient or helpful for clarity. The same or analogous reference to these elements will be made in the body of the specification, but other names and terminology may also be employed to further explain the present invention.

### GENERAL DESCRIPTION OF THE INVENTION, DETAILED DESCRIPTION OF PREFERRED EMBODIMENTS OF AND BEST MODE FOR CARRYING OUT THE PRESENT INVENTION

The present invention provides a process comprising the evaluation, planning, and provision of maintenance and repair services for water storage facilities on an ongoing, integrated and monitored basis including the use of comprehensive maintenance and state of the art cleaning and circulation technologies.

The present invention comprises a process for the maintenance and repair of water storage facilities comprising:
(a) evaluating and planning for maintenance and repair services for water storage facilities;
(b) providing comprehensive maintenance of said water storage facilities;
(c) providing initial cleaning of said water storage facilities;
(d) providing periodic cleaning of said water storage facilities thereafter; and
(e) providing circulation of the water in said water storage facilities between said periodic cleanings.

The provision of the services may be based on ongoing monitoring of the compliance with regulatory requirements within the water storage facility, including the computer monitoring of physical, chemical and/or biological conditions within the water storage facility.

In many if not most cases the water storage facility includes a water storage tank. The circulation of the water in the water storage facility is intended to provide for laminar or near laminar flow in the circulation patterns of the water. The cleaning of the tank includes chemical cleaning, and the effective removal of chemical and biological deposits, to render the system safe as a potable water source.

The cleaning pattern which is preferred will produce a saw-tooth pattern as measured by the amount of one or more chemical/biological contaminants being monitored. The saw tooth curve will have maximum and minimum points which are repeated more than once in the time period that would otherwise lead to system failure, major repair, or replacement.

The cleaning technology to be employed may include any of the above mentioned cleaning agents, however the presently preferred agents are those of Floran Technologies Inc., of Oklahoma City, Okla. and are described in U.S. Pat. Nos. 7,183,246; 6,346,217; and 6,309,470 which are incorporated herein by reference.

The circulation technologies include any and all as disclosed above, however the preferred circulation technology is that available from SolarBee, Inc of Dickinson N. Dak. aka/dba PSI-ETS and Partnership. This technology is disclosed in U.S. Pat. Nos. 6,439,853; 6,432,302; and 7,121,536 which are incorporated herein by reference.

Other applications of the present invention may include filter media, basins and tanks and air towers

For a further understanding of the nature, function, and objects of the present invention, reference should now be made to the following detailed description taken in conjunction with the accompanying drawings. Detailed descriptions of the preferred embodiments are provided herein, as well as, the best mode of carrying out and employing the present invention. It is to be understood, however, that the present invention may be embodied in various forms, Therefore, specific details disclosed herein are not to be interpreted as limiting, but rather as a basis for the claims and as a representative basis for teaching one skilled in the art to employ the present invention in virtually any appropriately detailed system, structure, or manner. The practice of the present invention is illustrated by the following examples, which are deemed illustrative of both the process taught by the present invention and of the results yielded in accordance with the present invention.

### ALTERNATIVES

While throughout this description, we have referred to various materials, chemicals, and apparatus as being presently preferred, it will be clear to one skilled in the art that other materials, chemicals, and steps may be employed which will also provide the advantages as herein set forth in connection with the present invention.

### SUMMARY

The present invention provides a process comprising the evaluation, planning, and provision of maintenance and repair services for water storage facilities on an ongoing, integrated and monitored basis including the use of comprehensive maintenance and state of the art cleaning and circulation technologies.

The present invention comprises a process for the maintenance and repair of water storage facilities comprising:
(a) evaluating and planning for maintenance and repair services for water storage facilities;
(b) providing comprehensive maintenance of said water storage facilities;
(c) providing initial cleaning of said water storage facilities;
(d) providing periodic cleaning of said water storage facilities thereafter; and
(e) providing circulation of the water in said water storage facilities between said periodic cleanings.

The provision of the services may be based on ongoing monitoring of the compliance with regulatory requirements within the water storage facility, including the computer monitoring of physical, chemical and/or biological conditions within the water storage facility.

In many if not most cases the water storage facility includes a water storage tank. The circulation of the water in the water storage facility is intended to provide for laminar or near laminar flow in the circulation patterns of the water. The cleaning of the tank includes chemical cleaning, and the effective removal of chemical and biological deposits, to render the system safe as a potable water source.

The cleaning pattern which is preferred will produces a saw-tooth pattern as measured by the amount of one or more chemical/biological contaminants being monitored. The saw tooth curve will have maximum and minimum points which are repeated more than once in the time period that would otherwise lead to system failure, major repair, or replacement.

It is noted that the embodiment described herein in detail for exemplary purposes is, of course, subject to many different variations in structure, design application, and methodology. Because many varying and different embodiments may be made within the scope of the inventive concepts herein taught, and because many modifications may be made in the embodiment herein detailed in accordance with the descriptive requirement of the law, it is to be understood that the details herein are to be interpreted as illustrative and not in a limiting sense. It will be understood in view of the instant disclosure, that numerous variations of the invention are now enabled to those skilled in the art. Many of the variations reside within the scope of the present teachings. It is not intended to limit the scope of the invention to the particular forms set forth, but on the contrary, it is intended to cover such alternatives, modifications, and equivalents as may be included within the spirit and scope of the teachings of the present invention. Accordingly, the invention is to be broadly construed and is to be limited only by the spirit and scope of the claims appended hereto.

What is claimed is:

1. A process for the maintenance and repair of water storage facilities comprising:
(a) evaluating and planning for maintenance and repair services for water storage facilities;
(b) providing comprehensive maintenance of said water storage facilities;
(c) providing initial cleaning of said water storage facilities;
(d) providing periodic cleaning of said water storage facilities thereafter; and
(e) providing circulation of the water in said water storage facilities between said periodic cleanings.

2. The process of claim 1 wherein the provision of the services of claim 1 is based on ongoing monitoring of the compliance with regulatory requirements within the water storage facility.

3. The process of claim 2 wherein monitoring includes computer monitoring of physical, chemical and/or biological conditions within the water storage facility.

4. The process of claim 1 wherein the water storage facility includes a water storage tank.

5. The process of claim 1 wherein the circulation of the water in the water storage facility provides for laminar or near laminar flow in the circulation patterns of the water.

6. The process of claims 4 wherein the cleaning of the tank includes chemical cleaning.

7. The process of claim 6 wherein the cleaning of the tank includes effective removal of chemical and biological deposits.

8. The process of claim 7 wherein the cleaning of the tank renders the system safe as a potable water source.

9. The process of claim 8 wherein the cleaning pattern produces a saw-tooth pattern as measured by the amount of one or more chemical/biological contaminants being monitored.

10. The process of claim 9 wherein the said saw-tooth curve has maximum and minimum points which are repeated more than once in the time period that would otherwise lead to system failure, major repair, or replacement.
